(19) United States
(12) Patent Application Publication
(10) Pub. No.: US 2025/0333997 A1
(43) Pub. Date: Oct. 30, 2025

(54) FENESTRATION UNIT WITH FRAME MEMBER HAVING INTEGRALLY ATTACHED EXTERIOR LIP PROTRUSION

(71) Applicant: JELD-WEN, Inc., Charlotte, NC (US)

(72) Inventors: Grant Leavell, Spokane Valley, WA (US); Jake Buell, Spokane, WA (US)

(73) Assignee: JELD-WEN, Inc., Charlotte, NC (US)

(21) Appl. No.: 18/650,524

(22) Filed: Apr. 30, 2024

(51) Int. Cl. E06B 3/30; E06B 3/58

(52) U.S. Cl. CPC E06B 3/308; E06B 3/5821

(57) ABSTRACT

A frame system of a window fenestration unit includes a frame member that extends along a frame longitudinal axis. The frame member is unitary, and the frame member has a cross-sectional profile taken along a transverse axis that is normal to the frame longitudinal axis. The cross-sectional profile defines a total depth of the frame member measured along the transverse axis. The cross-sectional profile includes a panel support portion and an exterior lip protrusion that are arranged along the transverse axis. The exterior lip protrusion projects from the panel support portion along the transverse axis and terminates at an exterior lip end. The exterior lip protrusion has a lip depth measured along the transverse axis from the panel support portion to the exterior lip end. The lip depth is at least twenty percent (20%) of the total depth of the frame member.

### TECHNICAL FIELD

The technical field generally relates to a fenestration unit and, more particularly, relates to a fenestration unit with a frame member having an integrally attached exterior lip protrusion.

### BACKGROUND

It is known to provide various configurations of fenestration units. A window unit, for example, may include a panel (e.g., a glazing unit, a fixed pane, a sash, etc.) that is supported within a frame. Some door units may similarly include a frame that supports one or more door panels (e.g., swinging door panels, fixed panels, etc.) therein. The frame of the fenestration unit may be attached within a rough opening of a wall of a dwelling, building, structure, etc. for supporting the respective panel therein.

However, existing fenestration units may suffer from certain deficiencies. For example, in some construction configurations, the depth of the rough opening (between the interior and exterior of the structure) may be relatively large. In comparison, many conventional fenestration units have a significantly smaller depth dimension. Disadvantageously, extra labor and parts are typically needed to finish and fit the fenestration unit within the structure. There may also be increased material costs associated with using conventional fenestration units for this type of construction. Moreover, there may be limited options for positioning of the panel (e.g., the glazing unit, glass, fixed panel, etc.) relative to the surrounding wall of the structure, which may negatively affect sitelines, aesthetics, etc. Also, energy-efficiency may be compromised if these fenestration units are employed, and/or it may be more difficult to provide weather resistance using these fenestration units.

Thus, there remains a need for a fenestration unit, such as a window unit, that may be conveniently utilized in a larger range of construction types, including those structures having a rough opening with a larger depth. There is a need for such a fenestration unit, which also provides high thermal performance, energy efficiency, and weather resistance. Furthermore, there is a need for such a fenestration unit, which may be installed quickly and easily. Moreover, there is a need for lower-cost or otherwise improved manufacturing, assembly, and installation methods for such fenestration units. Other desirable features and characteristics will become apparent from the subsequent detailed description and the appended claims, taken in conjunction with the accompanying drawings and this background.

### BRIEF SUMMARY

In an example embodiment, a frame system of a window fenestration unit is disclosed that includes a frame member configured to attach within a rough opening of a structure and configured to support a panel therein. The frame member extends along a frame longitudinal axis. The frame member is unitary, and the frame member has a cross-sectional profile taken along a transverse axis that is normal to the frame longitudinal axis. The cross-sectional profile defines a total depth of the frame member measured along the transverse axis. The cross-sectional profile includes a panel support portion and an exterior lip protrusion that are arranged along the transverse axis. The exterior lip protrusion projects from the panel support portion along the transverse axis and terminates at an exterior lip end. The exterior lip protrusion has a lip depth measured along the transverse axis from the panel support portion to the exterior lip end. The lip depth is at least twenty percent (20%) of the total depth of the frame member.

In another example embodiment, a method of manufacturing a frame system of a window fenestration unit is disclosed. The method includes forming a frame member configured to attach within a rough opening of a structure and configured to support a panel therein. The frame member extends along a frame longitudinal axis. The frame member is unitary. The frame member has a cross-sectional profile taken along a transverse axis that is normal to the frame longitudinal axis. The cross-sectional profile defines a total depth of the frame member measured along the transverse axis. The cross-sectional profile includes a panel support portion and an exterior lip protrusion that are arranged along the transverse axis. The exterior lip protrusion projects from the panel support portion along the transverse axis and terminates at an exterior lip end. The exterior lip protrusion has a lip depth measured along the transverse axis from the panel support portion to the exterior lip end. The lip depth is at least twenty percent (20%) of the total depth of the frame member.

In an additional embodiment, a window fenestration unit is disclosed that includes a panel and a frame system having a frame member. The frame member is configured to attach within a rough opening of a structure and configured to support the panel therein. The frame member extends along a frame longitudinal axis. The frame member is unitary. The frame member has a cross-sectional profile taken along a transverse axis that is normal to the frame longitudinal axis. The cross-sectional profile defines a total depth of the frame member measured along the transverse axis. The cross-sectional profile includes a panel support portion and an exterior lip protrusion that are arranged along the transverse axis. The exterior lip protrusion projects from the panel support portion along the transverse axis and terminates at an exterior lip end. The exterior lip protrusion has a lip depth measured along the transverse axis from the panel support portion to the exterior lip end. The lip depth is at least twenty percent (20%) of the total depth of the frame member.

### BRIEF DESCRIPTION OF DRAWINGS

The various embodiments will hereinafter be described in conjunction with the following drawing figures, wherein like numerals denote like elements, and wherein:

FIG. 1 is a front view of a fenestration unit according to example embodiments;

FIG. 2 is a cross-sectional view of the fenestration unit of FIG. 1 taken along the line 2-2 of FIG. 1;

FIG. 3 is a cross-sectional view of a frame member of the fenestration unit of FIG. 1 according to example embodiments of the present disclosure;

FIG. 4 is a cross-sectional view of the fenestration unit according to additional embodiments of the present disclosure; and

FIG. 5 is a cross-sectional view of the frame member of the fenestration unit of FIG. 4.

### DETAILED DESCRIPTION

The following Detailed Description is merely exemplary in nature and is not intended to limit the various embodiments or the application and uses thereof. Furthermore, there is no intention to be bound by any theory presented in the preceding background or the following detailed description.

Broadly, example embodiments disclosed herein include a frame system for a fenestration unit, such as a window fenestration unit. The frame system may include a unitary, one-piece, frame member with features for facilitating assembly, installation, manufacture, etc. of the fenestration unit. The frame member may be a lineal extrusion (i.e., a part formed from an extrusion process). The frame member may extend along a straight longitudinal axis (i.e., a frame longitudinal axis) along an inner face of a rough opening of a structure. The frame member may also extend along an outer edge of a panel (e.g., a sash, a fixed glazing unit, an operating panel). The lineal extrusion may be configured for fixedly attaching to supporting structures that define the rough opening, and the lineal extrusion may include panel engaging features for supporting, sealing to, or otherwise cooperating with the panel to define the fenestration unit.

In some embodiments, the unitary, one-piece frame member may have a hollow cross-sectional profile taken perpendicular to the frame longitudinal axis. The frame member may be made from an extrudable material, such as vinyl, composite material, etc. The frame member may include a panel support portion configured to support the panel (e.g., a glazing unit, etc.) and an exterior lip protrusion. In the cross-sectional profile of the frame member, the panel support portion and the exterior lip protrusion may be arranged to cooperatively define a total depth dimension of the frame member. The exterior lip protrusion may extend from the panel support portion to define a lip depth dimension, and the lip depth dimension may be at least twenty percent (20%) of the total depth dimension of the frame member. The pronounced exterior lip protrusion may be suitable for extending from window framing members and over exterior insulation, rain shielding, cladding, veneer, and/or other structures disposed proximate the exterior side of the rough opening of the structure. The exterior lip protrusion may be integrally attached to the panel support portion for facilitating assembly of the fenestration unit. Also, the unitary frame member may improve and/or facilitate sealing of the fenestration unit within the rough opening.

The frame member may also provide an aesthetically pleasing offset of the panel from the exterior surface of the structure. In some embodiments, the frame member may be configurable for different rough openings of different structures. The frame member may be conveniently selected, varied, and/or otherwise configured for particular rough openings of different structures.

Because of the unitary frame member of the present disclosure, assembly and installation of the fenestration unit may be facilitated. The frame member itself may be used to both support the panel and to sealingly attach within the rough opening; therefore, extra flashing or other parts may be unnecessary. The fenestration unit may be assembled with one or more of the frame members, delivered to a job site, and installed with little-to-no modifications necessary for installation.

Moreover, the material of the frame members may provide high thermal performance, and thermal advantages. For example, the frame member may be constructed from thermally-efficient vinyl in some embodiments. Because of the frame member, the fenestration unit may also provide high resistance to moisture, rain, and/or wind intrusion into the structure.

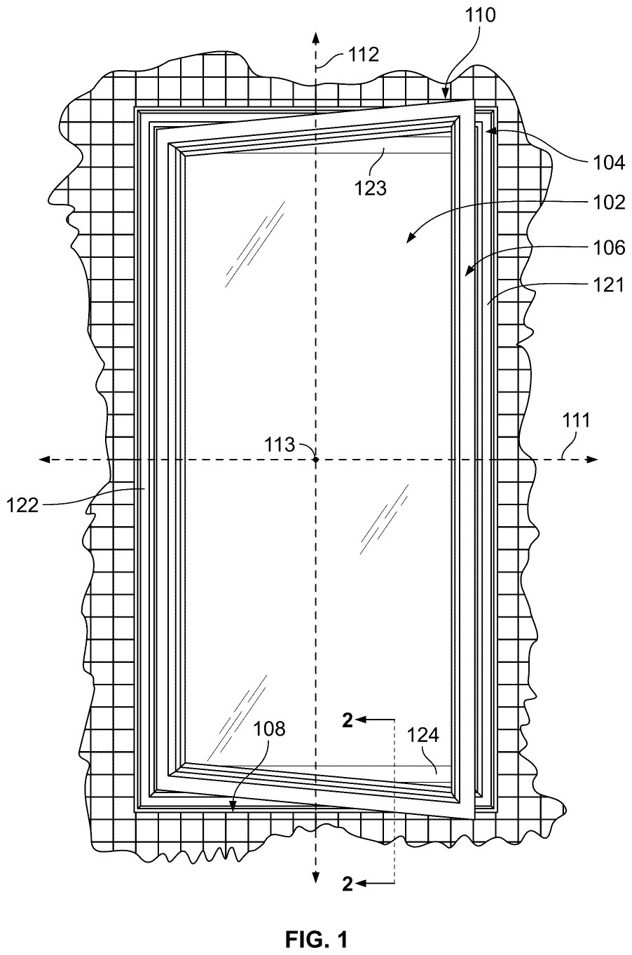

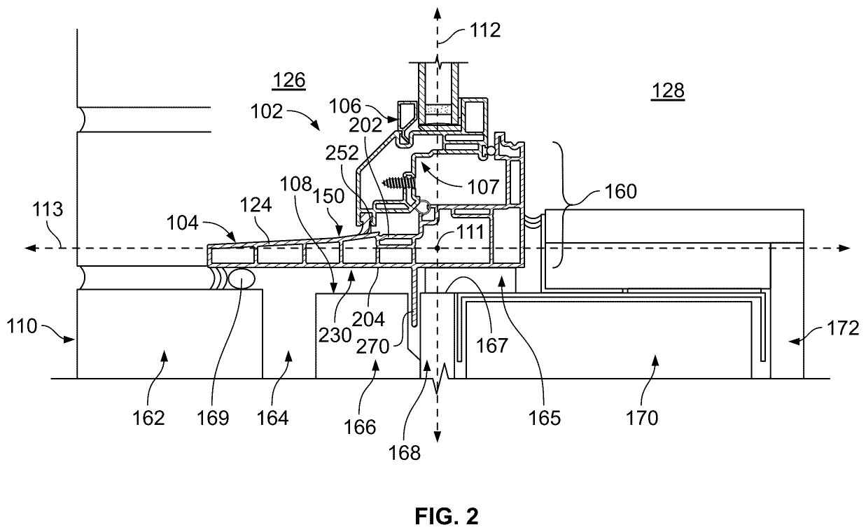

Referring initially to FIGS. 1 and 2, a fenestration unit 102 is illustrated according to example embodiments of the present disclosure. The fenestration unit 102 may be a window fenestration unit in some embodiments and may include a frame system 104 and at least one panel 106 that is supported therein. The frame system 104 may be attached within a rough opening 108 of a structure 110 (e.g., a house, apartment building, office building, etc.) so as to attach directly to the support structures (e.g., framing, etc.) defining the rough opening 108. The frame system 104 may support the panel 106 within the rough opening 108 of the structure 110.

In some embodiments, the fenestration unit 102 may be rectangular and substantially flat. Accordingly, the fenestration unit 102 may define a Cartesian coordinate system. Specifically, the fenestration unit 102 may define a first axis 111, a second axis 112, and a third axis 113, which are each normal (i.e., perpendicular) to the other two. The first axis 111 may extend horizontally between a first side jamb 121 and a second side jamb 122 of the frame system 104. The second axis 112 may extend vertically between a head jamb 123 and a sill 124 of the frame system 104. The third axis 113 (i.e., the transverse axis) may extend horizontally through the fenestration unit 102 between an exterior side 126 and an interior side 128 of the fenestration unit 102. As will be discussed, a depth dimension of the fenestration unit 102 (as well as that of the rough opening 108 may be measured and defined along the third axis 113.

The fenestration unit 102 may be of a variety of types without departing from the scope of the present disclosure. For example, the fenestration unit 102 may be a casement window in some embodiments; however, it will be appreciated that the fenestration unit 102 may be configured as a horizontally-sliding slider window unit or other type. Additionally, the term “panel” in referring to the panel 106 will be understood in a broad sense to generally apply to a wide number of configurations of fenestration units. The term “panel,” as used herein will be understood to apply, for example, to a window sash, an operable glazing unit, a fixed glazing unit, a pane of glass or other transparent material, etc.), which is configured to span across the rough opening 108.

In some embodiments, the panel 106 may be an operative, active, or moveable panel, which is selectively moveable within the frame system 104 between a closed position and an open position. In other embodiments, the panel 106 may be fixed within the frame system 104 (i.e., a non-operative panel). As shown in the embodiment of FIG. 1, the fenestration unit 102 may be a casement window fenestration wherein the panel 106 is pivotally attached to the second side jamb 122 for selective rotation about an axis of rotation that is parallel to the second axis 112 between the open and closed positions relative to the frame system 104. The panel 106 is shown partially opened and pivoted slightly outward from the frame system 104 in FIG. 1. The panel 106 is shown in the closed position in FIG. 2.

The frame system 104 may be configured for a variety of construction types of the structure 110. In the embodiment of FIG. 2, for example, the structure 110 may be of masonry-type, masonry vencer, or other construction type. The rough opening 108 may be collectively defined by a plurality of layers, sections, etc. For example, moving along the third axis 113 from the exterior side 126 to the interior side 128, an exterior brick finish 162, a rain screen 164, exterior insulation 166, exterior sheathing 168, wall framing 170, and interior wall panels 172 (e.g., drywall, sheetrock, etc.) may be included. The structure 110 may further include at least one shim member 165 within the assembly, e.g. for supporting the fenestration unit 102 on the wall framing 170. These features may collectively define an inner face 167 of the rough opening 108, which faces generally inward toward the center of the rough opening 108 (i.e., toward a center axis that is parallel to the third axis 113). The inner face 167 may have a substantially large depth dimension measured along the third axis 113, for example, due to the inclusion of the brick finish 162 and the rain screen 164. However, the frame system 104 may be configured for such larger-depth rough openings 108. The frame system 104 may be useful for masonry buildings such as those represented in FIGS. 1 and 2, and the frame system 104 may also be useful for structures 110 having 2×6 or 2×8 framed rough openings 108.

As shown in FIG. 2, the frame system 104 may include a frame member 150 that is unitary (i.e., a one-piece part with various features that are integrally connected together). The frame member 150 may be included at the sill 124 and may define a majority thereof as shown in the cross-section of FIG. 2. It will be appreciated that features of the frame member 150 of FIG. 2 may be included on one or both side jambs 121, 122. Furthermore, it will be appreciated that features of the frame member 150 of FIG. 2 may be included on the head jamb 123. In some embodiments, the frame system 104 may include the frame member 150 on the sill 124, the first side jamb 121, the second side jamb 122, and the head jamb 123. In these embodiments, the frame system 104 may include, for example, four of the frame members 150 assembled end-to-end and connected at respective corners of the frame system 104.

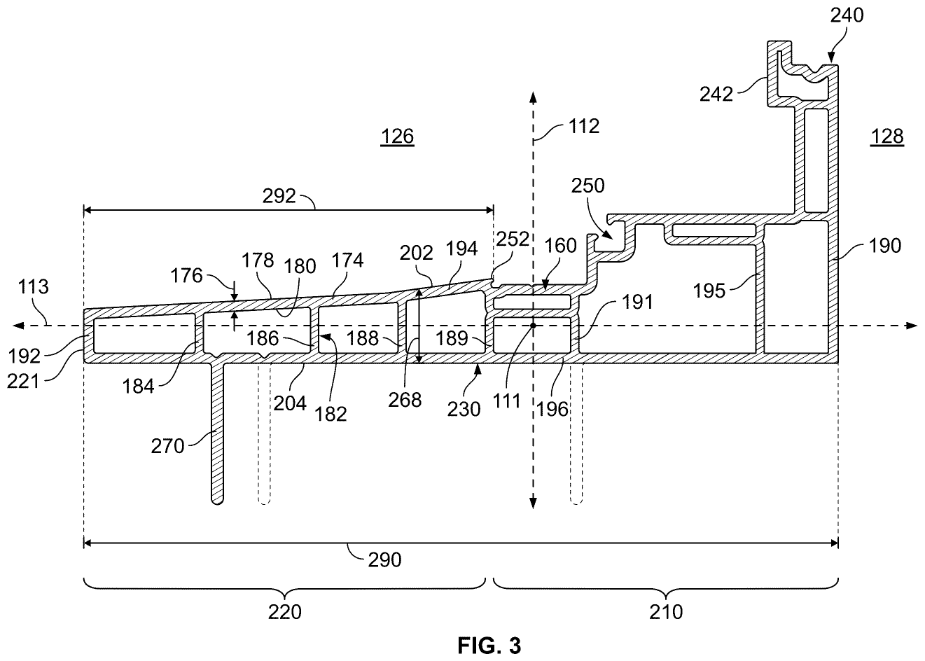

As shown in FIG. 3, the frame member 150 may define a cross-sectional profile 160 that is substantially hollow. The frame member 150 may extend along the first axis 111 (i.e., the frame longitudinal axis), and the profile 160 may remain substantially constant along the first axis 111. The profile 160 may include a thin outer profile wall 174 with a wall thickness 176. The outer profile wall 174 may extend about the cross-sectional profile 160 to define an exterior surface 178 of the frame member 150, and the outer profile wall 174 may define one or more internal surfaces 180 that defines the hollow interior of the frame member 150. The outer profile wall 174 may generally include an interior end wall portion 190 and an exterior end wall portion 192, which may extend along the second axis 112 and may be spaced apart along the third axis 113, and the outer profile wall 174 may include an inner face wall portion 194 and an outer face wall portion 196, which may extend generally along the third axis 113 between the interior end wall portion 190 and the exterior end wall portion 192. As shown in FIG. 2, the inner face wall portion 194 defines an inward-facing side 202 that is nonplanar and faces generally toward the third axis 113 and toward the panel 106. The outer face wall portion 196 defines an outward-facing side 204 that is planar and that faces generally away from the third axis 113 and toward the inner face 167 of the rough opening 108.

The cross-sectional profile 160 of the frame member 150 may include a panel support portion 210 and an exterior lip protrusion 220. The panel support portion 210 and the exterior lip protrusion 220 may be arranged apart side-by-side along the third axis 113. The panel support portion 210 may define the frame system 104 at the interior side 128, and the exterior lip protrusion 220 may project along the third axis 113 and away from the panel support portion 210 to define the frame member 150 at the exterior side 126 of the fenestration unit 102. The panel support portion 210 may support the panel 106, for example, as shown in FIG. 2, and the panel support portion 210 may extend over and about a periphery 107 of the panel 106. The exterior lip protrusion 220 may project from the panel support portion 210 along the third axis 113 and terminate at an exterior lip end 221 of the end wall portion 192.

The profile 160 of the frame member 150 may also include one or more internal ribs 182 that extend within the interior, between opposing internal surfaces 180 of the outer profile wall 174. In some embodiments, there may be a plurality of internal ribs 182, such as a first rib 184, a second rib 186, a third rib 188, a fourth rib 189, a fifth rib 191, and a sixth rib 195, which may be planar and disposed within a plane defined by the first and second axes 111, 112, and which may be spaced apart from each other at a distance along the third axis 113. A large majority of the interior of the profile 160 may be hollow, but the ribs 182 may sub-divide and separate the hollow interior into segments. The ribs 182 may also add stiffness and resistance against bending of the frame member 150. The wall thickness 176 of the outer profile wall 174 may be substantially constant across a majority of the profile 160, and the ribs 182 may have a similar wall thickness.

In some embodiments, the first rib 184, the second rib 186, and the third rib 188 may be disposed within the exterior lip protrusion 220. The fifth and sixth ribs 191, 195 may be disposed within the panel support portion 210. Moreover, the fourth rib 189 may be disposed at a junction 230 where the exterior lip protrusion 220 is joined to the panel support portion 210.

The panel support portion 210 may be configured for supporting and/or scaling with the casement-style panel 106 of FIG. 2. Thus, the panel support portion 210 may have a stepped cross-section and may include an interior ridge 240 (i.e., crown) that projects inwardly along the second axis 112 toward the center axis of the fenestration unit 102 parallel to the third axis 113. The interior ridge 240 may include a seal surface 242 for weatherstripping or other seal members of the panel 106 to seal against when in the closed position. The seal surface 242 may face outward toward the exterior side 126 of the fenestration unit 102. Also, the panel support portion 210 may include a channel 250 that is spaced toward the exterior side 126 along the third axis 113 from the interior ridge 240. As shown in FIG. 2, the channel 250 may be configured to receive weatherstripping and/or for engaging a seal member of the panel 106. Moreover, the panel support portion 210 may include an inward-facing seal surface 252, which is included proximate the junction 230 and which is configured for sealing with the panel 106 when in the closed position. More specifically, the exterior lip protrusion 220 may be integrally attached to the panel support portion 210 at the seal surface 252, and the exterior lip protrusion 220 may project therefrom in the exterior direction along the third axis 113.

Furthermore, the exterior lip protrusion 220 may project from the junction 230 with a lip thickness 268 (measured along the second axis 112). The thickness 268 may taper slightly downward as the exterior lip protrusion 220 extends in the exterior direction along the third axis 113.

Additionally, the frame member 150 may include a fin 270 (e.g., a nail fin, etc.) that is integrally attached to the outer profile wall 174. The fin 270 may be a flange that projects from the outward-facing side 204 along the second axis 112. In some embodiments, the fin 270 may be disposed in a position along the third axis 113 so as to project from the exterior lip protrusion 220. One such position is shown in solid lines in FIG. 3 as an optional position of the fin 270. Another such position of the fin 270 is shown in phantom in FIG. 3. As represented in phantom in FIG. 3, the fin 270 may be positioned so as to project from the panel support portion 210. When installed (FIG. 2), the fin 270 may overlap a member of the structure 110. In some embodiments, the fin 270 may fixedly attach to the exterior sheathing 168 with nails or other fasteners. The frame member 150 may include the fin 270 at one or more of the positions represented in FIG. 3 so as to attach the fenestration unit 102 in a desired position relative to the rough opening 108 along the third axis 113. Thus, the frame member 150 may be configured according to a number of installation positions, according to a desired depth position of the panel 106, or according to other considerations.

The frame member 150 may be formed from a material that is suitable for an extrusion process. Also, the frame member 150 may made from a lightweight material. The frame member 150 may be made from a material that provides high thermal performance (e.g., a thermally insulative material). In some embodiments, the frame member 150 may be extruded from a polymeric material (e.g., a vinyl material). In some embodiments, the frame member 150 may be extruded from a composite material having a polymeric matrix material. Thus, the frame member 150 may be advantageously rigid, stiff, strong, robust, thermally efficient, lightweight, and highly manufacturable.

The outward-facing side 204 of the outer face wall portion 196 may be flat and planar for fitting and attaching within the rough opening 108. As shown in FIG. 2, the outward-facing side 204 may overlap the shim member 165 to be supported within the rough opening. The fin 270 may overlap and attach to the exterior sheathing 168. As shown in FIG. 2, the exterior lip protrusion 220 may extend over and cover the exterior insulation 166, the rain screen 164, and the exterior brick finish 162 of the rough opening 108 (i.e., layers disposed at the exterior side 126 of the rough opening 108). In some embodiments, the exterior lip protrusion 220 may seal with an applied sealant bead 169 to the exterior brick finish 162 for robust resistance against precipitation, wind, etc.

A total depth dimension 290 of the frame member 150 may be measured along the third axis 113 and along the outward-facing side 204 of the outer face wall portion 196 from the interior end wall portion 190 to the exterior lip end 221. The exterior lip protrusion 220 may have a lip depth 292 measured along the third axis 113 from panel support portion 210 to the exterior lip end 221 (i.e., from the junction 230 to the exterior lip end 221).

A substantial portion of the total depth dimension 290 may be defined by the lip depth 292 of the exterior lip protrusion 220. The lip depth 292 may be at least twenty percent (20%) of the total depth 290 of the frame member 150 in some embodiments. As shown in FIG. 3, the lip depth 292 may be more than thirty percent (30%) of the total depth 290 of the frame member 150 in some embodiments. In further embodiments, the lip depth 292 is more than forty percent (40%) of the total depth 290 of the frame member 150.

Specifically, the total depth dimension 290 may be approximately 6.0 inches (approximately 15.2 centimeters), and the lip depth 292 may be approximately 3.2 inches. Thus, in embodiments such as these, the lip depth 292 may be more than fifty percent (50%) of the total depth 290 of the frame member 150. (“Approximately” is used in this context to account for reasonable manufacturing tolerances.)

Accordingly, the relatively large and pronounced exterior lip protrusion 220 of the fenestration unit 102 may provide convenience. The fenestration unit 102 may be assembled with the frame system 104 ready for installation. The exterior lip protrusion 220 is integrally included and configured for spanning in the exterior direction over the structure 110 and, in some embodiments, seal with the sealant bead 169 to the structure 110. Furthermore, the frame system 104 allows the panel 106 to be deeply inset relative to the rough opening 108 of the structure 110. The frame system 104 may also be configurable, for example, by providing the fin 270 in one of the various positions represented in FIG. 3; therefore, the fenestration unit 102 may be useful for a wide variety of construction types of the structure 110.

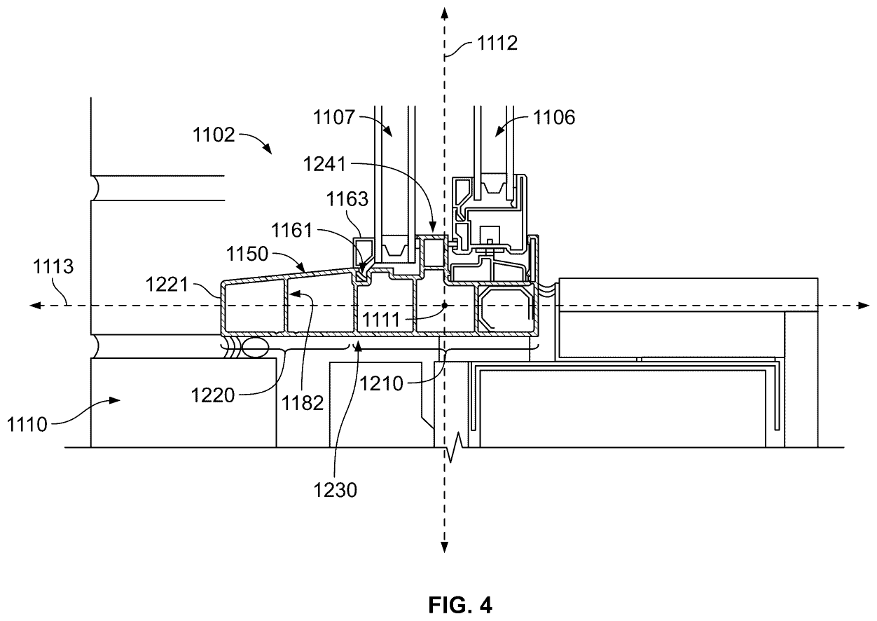

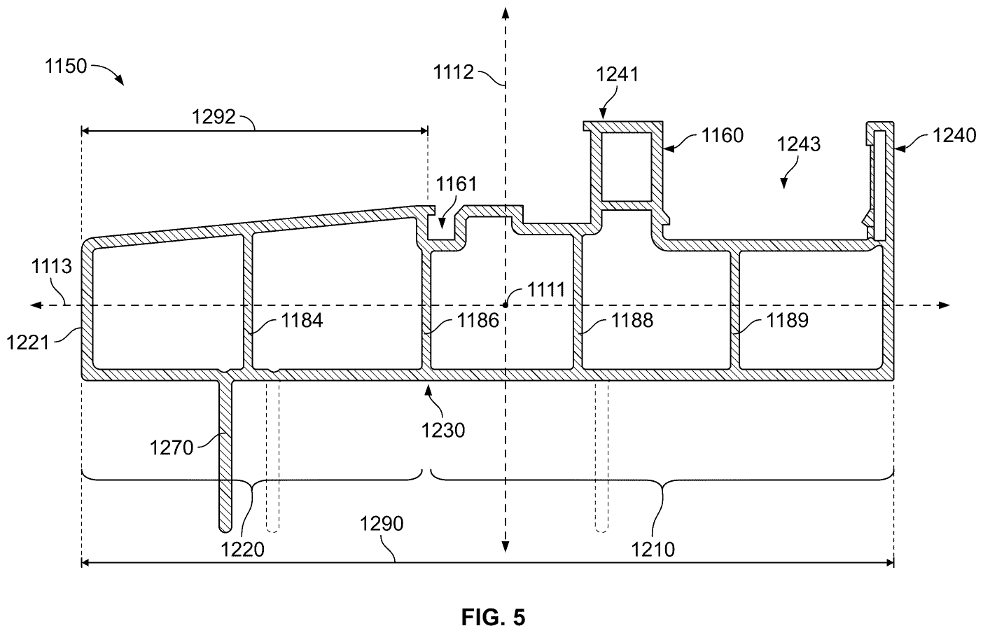

Referring now to FIGS. 4 and 5, additional embodiments of the present disclosure will be discussed. Components that correspond to those of FIGS. 1-3 are indicated with corresponding reference numbers increased by 1000.

The fenestration unit 1102 may be configured as a multi-panel slider window fenestration unit 1102. Thus, the fenestration unit 1102 may include an operable panel 1106 and a fixed panel 1107. The frame system 1104 may support both the operable panel 1106 and the fixed panel 1107 with the operable panel 1106 spaced apart slightly along the third axis 1113. The operable panel 1106 may be a horizontally-sliding panel 1106 with a glazing unit and may be supported for sliding along the first axis 1111. The fixed panel 1107 may be in a fixed position along the first axis 1111.

The frame member 1150 may include the panel support portion 1210 and the exterior lip protrusion 1220. The panel support portion 1210 may be configured for supporting the operable panel 1106 and the fixed panel 1107. Accordingly, the profile 1160 of the frame member 1150 may include the interior ridge 1240 and an intermediate ridge 1241, which defines a panel gap 1243 that receives the operable panel 1106. The profile 1160 may also include a bead engagement feature 1161 for removably attaching a bead member 1163 to the frame member 1150. In some embodiments, the bead engagement feature 1161 may be a channel that receives and engages to the elongate bead member 1163 to support the fixed panel 1107 against the exterior-facing side of the intermediate ridge 1241. The junction 1230 may be defined at the bead engagement feature 1161, and the exterior lip protrusion 1220 may be integrally attached thereto. The exterior lip protrusion 1220 may extend in the exterior direction therefrom along the third axis 1113. Also, the profile 1160 may include the interior ribs 1182. The first rib 1184 may be disposed in the exterior lip protrusion 1220, and the second rib 1186 may be disposed at the junction 1230. The third rib 1188 and the fourth rib 1189 may be disposed in the panel support portion 1210.

The frame member 1150 may further include the fin 1270. The position of the fin 1270 along the third axis 1113 may be in one of the three positions indicated in FIG. 5. One of these positions is shown in solid lines, and two other optional positions are indicated with broken lines. Thus, the fenestration unit 102 may be configured, for example, with frame members 150 preselected according to the placement of the fin 1270 along the third axis 1113.

Like the embodiments of FIG. 1-3, the frame member 1150 may be constructed via an extrusion process. Also, the frame member 1150 may be formed from a polymeric material, such as PVC, or a composite material with a polymeric matrix material.

The lip depth 1292 may define a substantial amount of the total depth dimension 1290. For example, in some embodiments, the total depth dimension 1290 may be approximately six inches (6.0 in.), and the lip depth 1292 may be approximately 2.5 inches. Thus, the lip depth 1292 may be over forty percent (40%) of the total depth dimension 1290.

Thus, the frame system 1104 may provide the advantages of the frame system 104 defined above in a slider window fenestration configuration. The frame systems 104, 1104 of the present disclosure may include a unitary and one-piece frame member 150, 1150 that can robustly support one or more panels 106, 1106, 1107 within a rough opening, and the integrally-attached exterior lip protrusion 220, 1220 may span in the exterior direction a relatively long distance and terminate proximate the exterior of the structure. The exterior lip end 221, 1221 may be conveniently sealed to the structure 110, 1110. The frame system 1104 may also be configured for a number of construction types of the structure 110, 1110 and to position the panels 106, 1106, 1107 in a variety of positions relative thereto.

A manufacturing system may be employed to manufacture and otherwise provide different frame members 150, 1150 of different dimensions, different fin positions, etc. The different lines of different frame members 150, 1150 may be efficiently manufactured using extrusion processes.

In some manufacturing systems of the present disclosure, a customer may select and order a fenestration unit 102, 1102 assembled from frame members 150, 1150 that are sized and configured for the customer's premeasured rough opening 108, 1108. The fenestration unit 102, 1102 may arrive to the job site assembled and ready for installation without having to attach extra parts. The fenestration unit 102, 1102 may also be convenient for attaching and sealing to the structure 110, 1110.

In some embodiments, the fenestration unit 102, 1102 may be useful for multi-story structures 110, 1110 (e.g., apartment buildings, office buildings, high-rise buildings, etc.). The fenestration unit 102, 1102 may be relatively lightweight, thermally efficient, and may provide a robust barrier against wind, rain, or other precipitation.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing an exemplary embodiment of the disclosure. It is understood that various changes may be made in the function and arrangement of elements described in an exemplary embodiment without departing from the scope of the disclosure as set forth in the appended claims.

What is claimed is:

1. A frame system of a window fenestration unit comprising:
a frame member configured to attach within a rough opening of a structure and configured to support a panel therein, the frame member extending along a frame longitudinal axis, the frame member being unitary, the frame member having a cross-sectional profile taken along a transverse axis that is normal to the frame longitudinal axis, the cross-sectional profile defining a total depth of the frame member measured along the transverse axis, the cross-sectional profile including a panel support portion and an exterior lip protrusion that are arranged along the transverse axis;
the exterior lip protrusion projecting from the panel support portion along the transverse axis and terminating at an exterior lip end; and
the exterior lip protrusion having a lip depth measured along the transverse axis from the panel support portion to the exterior lip end, the lip depth being at least twenty percent (20%) of the total depth of the frame member.

2. The frame system of claim 1, wherein the lip depth is more than thirty percent (30%) of the total depth of the frame member.

3. The frame system of claim 2, wherein the lip depth is more than forty percent (40%) of the total depth of the frame member.

4. The frame system of claim 1, wherein the frame system is configured for a casement window fenestration unit with the panel pivotally attached to the frame system for movement between an open position and a closed position relative to the frame member, the panel support portion including a seal surface for sealing with the panel in the closed position, the exterior lip protrusion integrally attached to the panel support portion at the seal surface.

5. The frame system of claim 1, wherein the frame system is configured for a slider window fenestration unit, the panel support portion includes a bead engagement feature for attaching a bead member to the frame member; and
wherein the exterior lip protrusion is integrally attached to the panel support portion at the bead engagement feature.

6. The frame system of claim 1, wherein the frame member includes an inner side that faces the panel and an outer side that faces away from the panel, the frame member including a fin that is integrally attached to the outer side and that projects from the outer side.

7. The frame system of claim 6, wherein the fin projects away from the panel support portion.

8. The frame system of claim 6, wherein the fin projects away from the exterior lip protrusion.

9. The frame system of claim 1, wherein the cross-sectional profile is hollow with an outer profile wall and a planar internal rib that extends between opposing internal surfaces of the outer profile wall.

10. The frame system of claim 9, wherein the planar internal rib is disposed within the exterior lip protrusion.

11. The frame system of claim 10, wherein the planar internal rib is a first rib, wherein the cross-sectional profile includes a second rib that is planar and that extends between the opposing internal surfaces of the outer profile wall, the first rib and the second rib being spaced apart at a distance along the transverse axis.

12. The frame system of claim 11, wherein the first rib and the second rib are disposed within the exterior lip protrusion.

13. The frame system of claim 1, wherein the frame member is constructed of a polymeric material.

14. A method for manufacturing a frame system of a window fenestration unit, the method comprising:
forming a frame member configured to attach within a rough opening of a structure and configured to support a panel therein, the frame member extending along a frame longitudinal axis, the frame member being unitary, the frame member having a cross-sectional profile taken along a transverse axis that is normal to the frame longitudinal axis, the cross-sectional profile defining a total depth of the frame member measured along the transverse axis, the cross-sectional profile including a panel support portion and an exterior lip protrusion that are arranged along the transverse axis;
the exterior lip protrusion projecting from the panel support portion along the transverse axis and terminating at an exterior lip end; and
the exterior lip protrusion having a lip depth measured along the transverse axis from the panel support portion to the exterior lip end, the lip depth being at least twenty percent (20%) of the total depth of the frame member.

15. The method of claim 14, wherein forming the frame member includes extruding the frame member.

16. A window fenestration unit comprising:
a panel; and
a frame system having a frame member, the frame member configured to attach within a rough opening of a structure and configured to support the panel therein, the frame member extending along a frame longitudinal axis, the frame member being unitary, the frame member having a cross-sectional profile taken along a transverse axis that is normal to the frame longitudinal axis, the cross-sectional profile defining a total depth of the frame member measured along the transverse axis, the cross-sectional profile including a panel support portion and an exterior lip protrusion that are arranged along the transverse axis;
the exterior lip protrusion projecting from the panel support portion along the transverse axis and terminating at an exterior lip end; and
the exterior lip protrusion having a lip depth measured along the transverse axis from the panel support portion to the exterior lip end, the lip depth being at least twenty percent (20%) of the total depth of the frame member.

17. The window fenestration unit of claim 16, wherein the frame system is configured as a casement window fenestration unit wherein the panel is pivotally attached to the frame system for movement between an open position and a closed position relative to the frame member.

18. The window fenestration unit of claim 17, wherein the panel support portion includes a seal surface for sealing with the panel in the closed position, the exterior lip protrusion integrally attached to the panel support portion at the seal surface.

19. The window fenestration unit of claim 16, wherein the frame system is configured as a slider window fenestration unit.

20. The window fenestration unit of claim 19, wherein the panel support portion includes a bead engagement feature for attaching a bead member to the frame member; and
wherein the exterior lip protrusion is integrally attached to the panel support portion at the bead engagement feature.
